(19) United States
(12) Patent Application Publication
(10) Pub. No.: US 2026/0350504 A1
(43) Pub. Date: Nov. 5, 2026

(54) System and Method for Customized AI Travel Advisor

(71) Applicant: Aravind Chinnaraju, Redmond, WA (US)

(72) Inventor: Aravind Chinnaraju, Redmond, WA (US)

(21) Appl. No.: 19/197,963

(22) Filed: May 2, 2025

(51) Int. Cl. G06Q 10/0631; G06Q 10/02

(52) U.S. Cl. CPC G06Q 10/06315; G06Q 10/02

(57) ABSTRACT

The disclosed invention is an AI-powered system for generating personalized travel itineraries based on user preferences. Users input natural language queries including destination, mood, travel purpose, companion type, and budget. The system categorizes activities into Popular, Hidden Gems, and Events, and supports four distinct workflows: activities-first, stay-first, activities-only, and stay-only. It dynamically suggests accommodations within a travel radius, factoring in walkability and sentiment analysis of reviews. The system integrates third-party travel APIs (e.g., Google, Viator, Ticket master) to validate results in real time, reducing AI hallucination and improving recommendation trust. A multi-layered optimization engine aligns itinerary components for cost, distance, and user satisfaction.

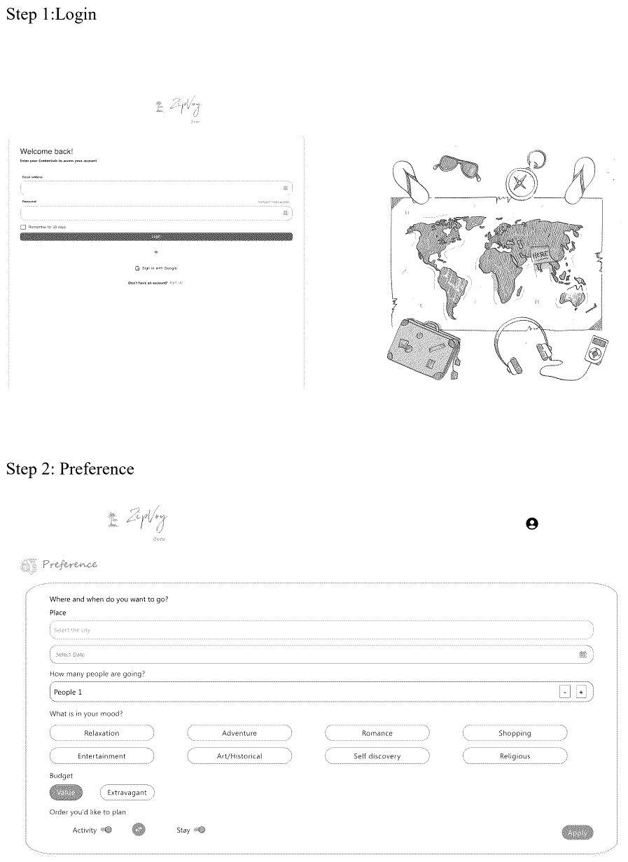

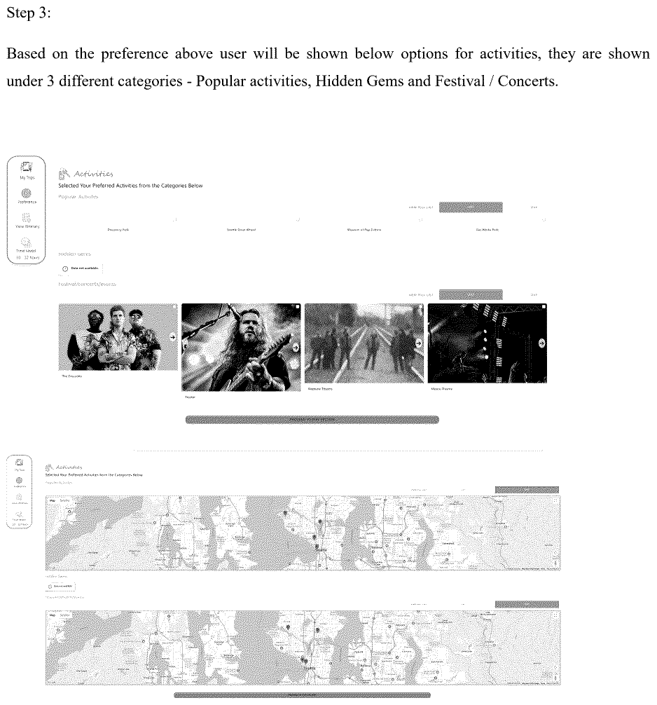

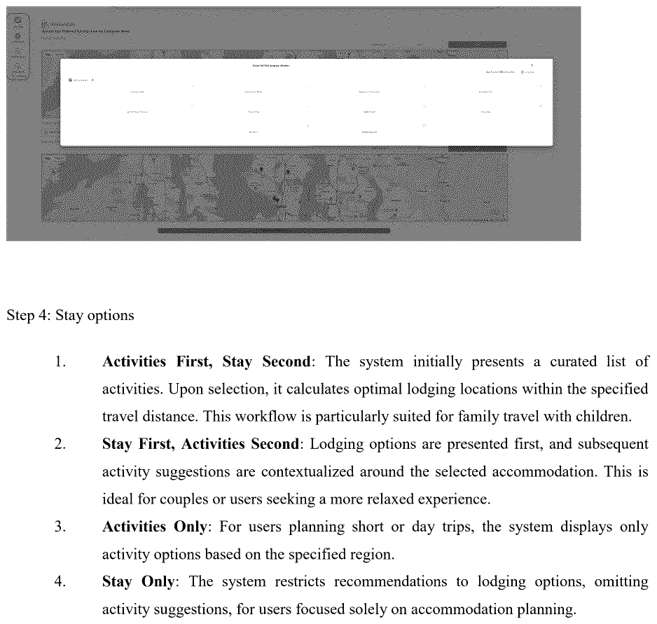

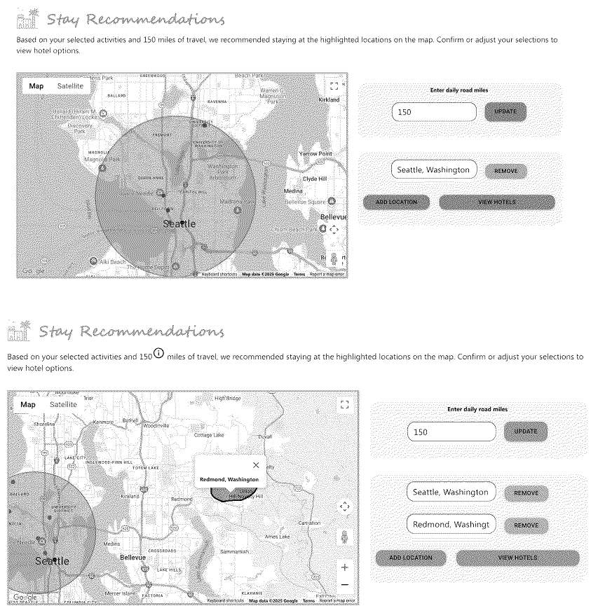

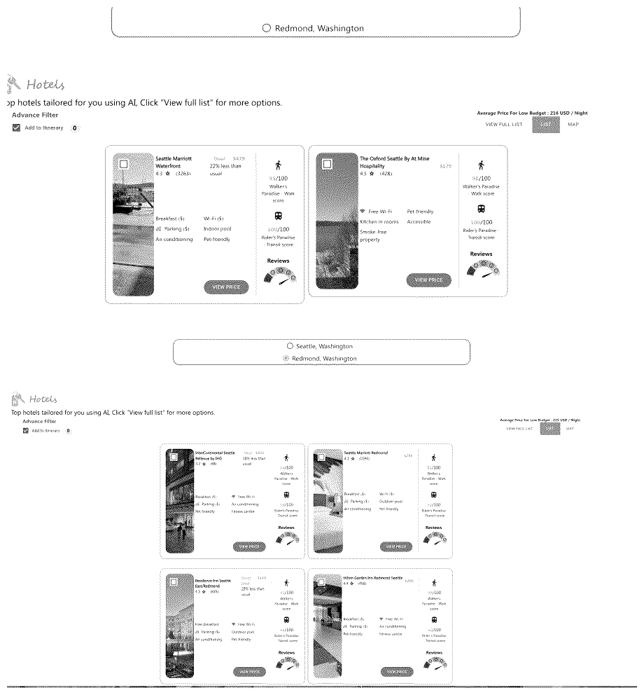

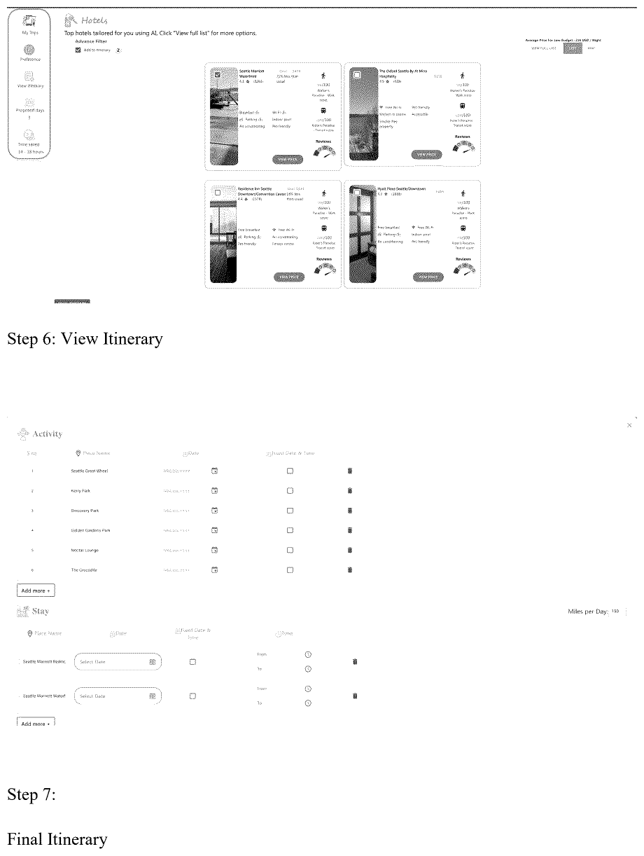

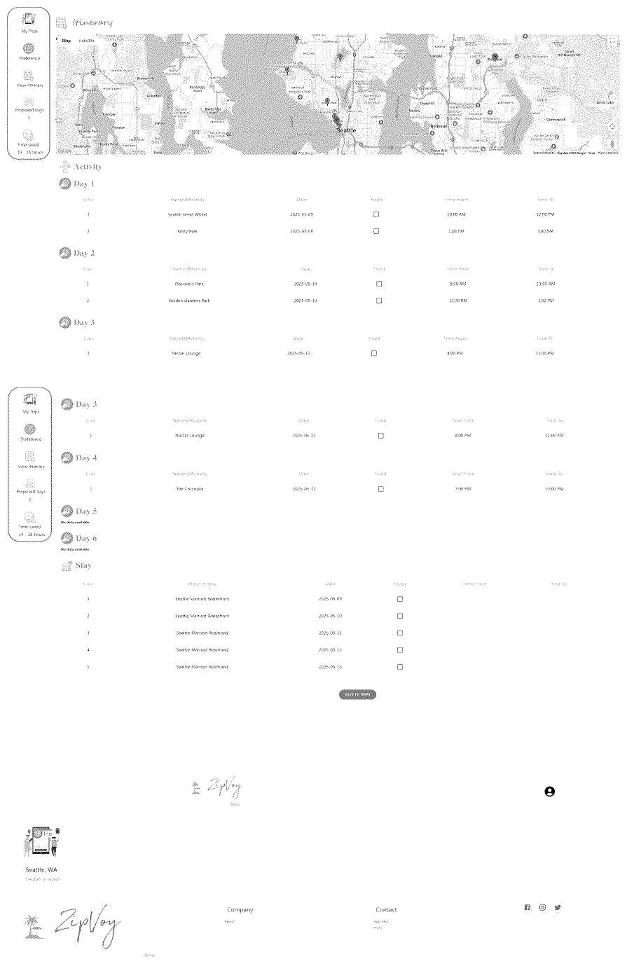

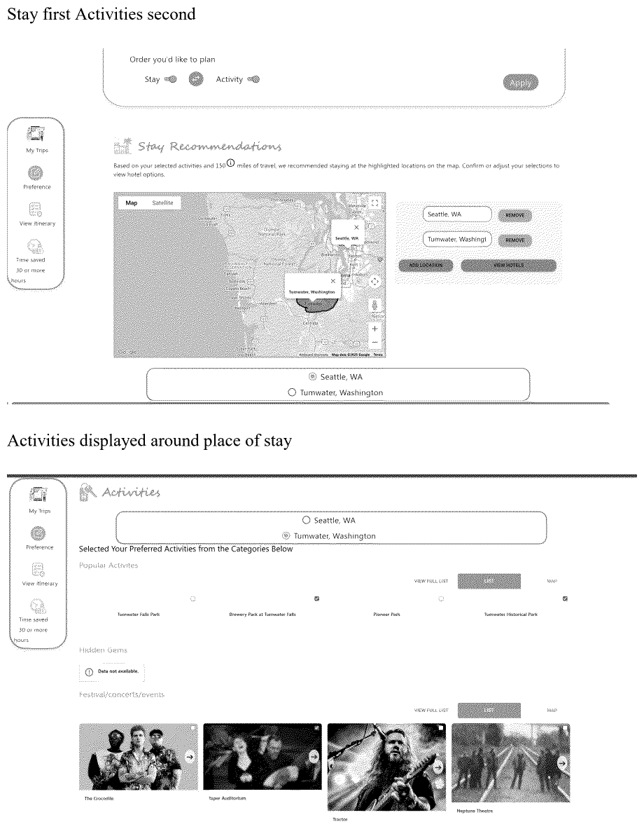

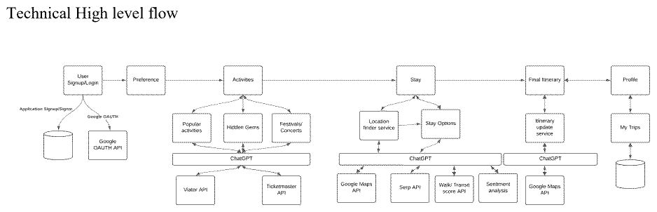

### BACKGROUND OF THE INVENTION

The present invention relates to systems and methods for providing intelligent, personalized travel planning using artificial intelligence. Existing travel planning methods are time-consuming and often lack customization. Traditional travel agents may not reflect the latest destinations, and AI chatbots frequently require highly specific prompts to deliver useful results. There is a need for a system that integrates user inputs such as mood, travel companions, and purpose to generate a tailored itinerary while leveraging third-party travel APIs to reduce hallucination and improve trustworthiness.

### SUMMARY OF THE INVENTION

This invention provides a personalized AI-based travel advisor that uses a natural language model to collect travel preferences—including destination, mood, travel companions, budget, and trip purpose—and generates an optimized itinerary. The system features four workflow modes: activities-first, stay-first, activities-only, and stay-only. It dynamically identifies lodging options within a preferred travel radius and integrates with travel platforms to validate suggestions.

### DETAILED DESCRIPTION OF THE INVENTION

1. Step 1: User logs into the application.
2. Step 2: User enters preferences including destination, travel purpose, mood, companion type, and budget.
3. Step 3: The system presents categorized activities: Popular, Hidden Gems, and Festivals/Concerts.
4. Step 4: Based on selected activities and travel radius, stay options are recommended. Users can define locations using a map or city input.
   Four workflows are supported:
   a) Activities First: Best suited for families with children.
   b) Stay First: Ideal for couples and relaxed itineraries.
   c) Activities Only: Designed for short or day trips.
   d) Stay Only: Focused on accommodation planning.
5. Step 5: The system displays hotel options along with walk scores and review sentiment.
6. Step 6: Users refine the itinerary by selecting or modifying activities and stays.
7. Step 7: Final itinerary is generated with optimal alignment to all preferences.

1. A computer-implemented system for generating a customized travel itinerary, comprising:
a preference collection module;
a recommendation engine configured to suggest activities and accommodations based on user preferences;
an optimization engine to minimize travel time and maximize experiential relevance; and
an integration layer to fetch validated data from third-party travel APIs.

2. The system of claim 1, wherein the user defines the preferred stay location by either drawing a region on a digital map or entering a city name.

3. The system of claim 1, wherein the itinerary generation supports four workflows: activities-first, stay-first, activities-only, and stay-only.
